(19) United States
(12) Patent Application Publication
(10) Pub. No.: US 2025/0391946 A1
(43) Pub. Date: Dec. 25, 2025

(54) SYSTEM FOR THE THERMAL REGULATION OF A BATTERY

(71) Applicant: PLASTIC OMNIUM CLEAN ENERGY SYSTEMS RESEARCH, Lyon (FR)

(72) Inventors: Rémi LASSON, Bruxelles (BE); Nicolas DERANGERE, Bruxelles (BE); Cosmin BARSAN, Bruxelles (BE)

(73) Assignee: PLASTIC OMNIUM CLEAN ENERGY SYSTEMS RESEARCH, Lyon (FR)

(21) Appl. No.: 18/857,605

(22) PCT Filed: Apr. 21, 2023
(86) PCT No.: PCT/EP2023/060414

§ 371 Date: Oct. 17, 2024

(30) Foreign Application Priority Data
Apr. 22, 2022 (FR) FR2203775

(51) Int. Cl. H01M 10/613; H01M 10/48; H01M 10/615; H01M 10/625; H01M 10/6567

(52) U.S. Cl. CPC H01M 10/613; H01M 10/48; H01M 10/615; H01M 10/625; H01M 10/6567

(57) ABSTRACT

A system for the thermal regulation of an immersion-type battery for a motor vehicle. The system includes a controller to monitor the quality of the dielectric heat-transfer liquid in order to ensure the correct operation of the battery.

### TECHNICAL FIELD OF THE INVENTION

The invention relates to the field of thermal regulation systems and in particular to such systems for a battery.

### BACKGROUND ART

Motor vehicles increasingly need electrical energy storage capacity, not least because of the anti-pollution standards imposed by local legislation. While the use of a battery enables an electric motor to replace all or part of a combustion engine and the pollution associated with its combustion, it does not replace it under the same conditions of use.

The first disadvantage is the battery's energy efficiency, which varies significantly according to temperature and the number of cycles performed (charges and discharges already carried out). It has been found that outside an optimum temperature range for the battery, generally between 25° C. and 40° C., energy efficiency drops sharply and comparatively much more than with a combustion engine. In particular, exceeding the ideal temperature range can lead to thermal runaway, which can result in a significant drop in energy efficiency, or even at least partial irreversible damage to the electrical energy storage cells.

This drawback has already been raised in documents WO 2021/073782, US 2010/136389, US 2011/262793, CN 214 625 171 U and WO 2021/134445.

A second disadvantage is that the higher the battery's current consumption, the greater the power discharged by the battery (with the Joule effect increasing as the square of the discharge current), and the greater the incentive for the user to use a fast charge terminal (with the Joule effect increasing as the square of the charge current).

As a result, forced convection cooling or heat exchanger cooling may no longer be sufficient to limit battery temperature. Thermal regulation of the battery is therefore becoming a major challenge for motor vehicles designed to meet increasingly stringent pollution standards.

### SUMMARY OF THE INVENTION

One of the aims of the invention is to provide a thermal regulation system for a motor vehicle battery that enables even a high-power battery to be used more safely and reliably for optimized and robust battery operation.

To this end, the object of the invention is a thermal regulation system for a motor vehicle battery comprising a closed hydraulic network in which a flow of single-phase dielectric heat-transfer liquid is formed by means of at least one pumping element, the hydraulic network comprising at least one battery module suitable for accommodating electrical energy storage cells intended to be thermally regulated by immersion in the single-phase dielectric heat-transfer liquid by means of at least partial filling of the battery module with the single-phase dielectric heat-transfer liquid, characterized in that the control system comprises at least one sensing element for sensing at least one physical value of the single-phase dielectric heat-transfer liquid, mounted on the hydraulic network and electrically connected to a control unit in order to selectively activate the operation of the thermal regulation system as a function of the physical value of the single-phase dielectric heat-transfer liquid measured by the sensing element, in order to ensure the good working order of the battery.

Advantageously, according to the invention, the control system is of the type involving at least partial immersion of the battery's electrical energy storage cells in a dielectric heat-transfer liquid, and preferably total immersion. Firstly, immersion is more efficient for heat exchange, as the specific exchange surface is larger. Secondly, evacuation from each module by circulation of the dielectric heat-transfer liquid is rapid, enabling high control efficiency and responsiveness to satisfy both the charging (at fast-charging stations) and discharging (electrical consumption of the motor vehicle at high load) of the battery's high electrical power. By the same token, immersion-type regulation is also safer against the spread of any battery fire in the motor vehicle. It is therefore understood that the thermal regulation system according to the invention makes it possible to maintain the electrical energy storage cells at their optimum temperature in order to guarantee optimized (maintenance of the best energy yield) and robust (optimum charging and discharging for a longer service life) operation of the battery whatever the external conditions in which the motor vehicle operates, i.e. even if it is very cold or very hot.

Advantageously, according to the invention, the dielectric heat-transfer liquid surrounding the electrical energy storage cells is continuously monitored to prevent pollution from being introduced into the battery module through the circulation of the dielectric heat-transfer liquid, which could render thermal regulation less effective or lead to short circuits between the electrical energy storage cells present in the module. It is understood that the thermal regulation system according to the invention therefore enables safer operation (maintenance of regulation quality) and greater reliability (maintenance of safe operating conditions for the regulation system/battery assembly, enabling a longer service life for the assembly). It can be concluded that the phenomena of battery thermal runaway will be avoided thanks to the thermal regulation system according to the invention, which will limit the situations in which irreversible damage to electrical energy storage cells could be caused.

In addition, this configuration makes it possible to continuously determine the presence or absence of pollution in the dielectric heat-transfer liquid simply by monitoring one of its physical values, without having to intervene in the hydraulic network, i.e. typically without having to take dielectric heat-transfer liquid samples from the hydraulic network. It is also possible under the invention to immediately detect whether the liquid used to fill the fluidic network is not the one expected. Preferably, when pollution is determined, the treatment unit blocks the circulation of the dielectric heat-transfer liquid in the hydraulic network by stopping at least the pumping element to prevent any pollution from entering each battery module as soon as possible.

Finally, the circulation of the dielectric heat-transfer liquid enables more accurate detection of any pollution than a passive system based on phase changes (liquid-gas), i.e. in particular without a flow-generating pump, whose absence of circulation does not enable rapid detection depending on where the pollution is introduced in relation to the position of the sensor and/or the inclination of the vehicle in which the thermal regulation system is installed.

Typically, the choice of a single-phase dielectric heat-transfer liquid enables a simple, compact system that can adapt to the dynamics of the vehicle in which the thermal regulation system is implemented, whereas the choice of a two-phase heat-transfer fluid entails a more complex and cumbersome system (hydraulic network and condenser required for each battery module) and whose vehicle dynamics may prevent the passive evaporation reaction.

The invention may also comprise one or more of the following optional features, taken alone or in combination.

Preferably, the sensing element is an electrical conductivity sensor (or an electrical resistivity sensor) so that the control unit selectively determines whether a risk of thermal deregulation (less efficient heat exchange) and/or a risk of short-circuit (possible electrical connection via the dielectric heat-transfer liquid) is incurred in the battery module by the presence of the single-phase dielectric heat-transfer liquid. Indeed, pollution is generally associated with a variation in electrical conductivity (electrical resistivity being the inverse of electrical conductivity) and this physical value has important consequences for the electrical connections in the battery module and, more generally, for battery operation. By way of example, the sensing element can be an electrode sensor.

The control unit's quality threshold, i.e. the threshold above which the control unit will consider that pollution is no longer negligible, may for example be an electrical conductivity σ at most equal to 1 nS·m⁻¹ or an electrical resistivity ρ at least equal to 1 GΩ·m at a temperature of 300 K. Indeed, depending on the temperature of the dielectric heat-transfer liquid, the electrical conductivity and, incidentally, the electrical resistivity, vary.

The sensing element can be mounted on the hydraulic network outside the battery module, enabling the control unit to stop the circulation of the single-phase dielectric heat-transfer liquid before it reaches each battery module when a predetermined threshold, such as the above quality threshold, is exceeded by the sensing element measurement. Typically, if there is an inlet for filling the hydraulic network with dielectric heat-transfer liquid, the sensing element could be installed downstream and as close as possible to this filling inlet to maximize the speed of detection of a fluid filling error, i.e. in particular if the liquid introduced into the hydraulic network is not the expected dielectric heat-transfer liquid, and sufficiently upstream of each battery module so that the inertia of the thermal regulation system does not cause the liquid to reach each battery module after the shutdown activated by the control unit.

The thermal regulation system may comprise a device for heating the single-phase dielectric heat-transfer liquid present in the hydraulic network in order to heat at least some of the electrical energy storage cells comprised in the battery module and/or a device for cooling the single-phase dielectric heat-transfer liquid present in the hydraulic network in order to cool at least some of the electrical energy storage cells comprised in the battery module. This means that the thermal regulation system can continuously adapt to the external conditions in which the motor vehicle is operating, i.e. both cold conditions (cell heating) and hot conditions (cell cooling). It is also immediate that the control unit can thus, in a first step, heat each battery module to arrive at the optimum battery operating temperature such as, for example, thirty degrees Celsius and, in a second step, thermally regulate (heat or cool) each battery module to maintain the optimum battery operating temperature.

The control unit can vary the flow rate of the single-phase dielectric heat-transfer liquid as a function of the physical value of the single-phase dielectric heat-transfer liquid measured by the sensing element. This makes it possible to dynamically adapt the thermal regulation system to the quality of the single-phase dielectric heat-transfer liquid. For example, for a given single-phase dielectric heat-transfer liquid whose heat transfer capacity (or coefficient) degrades over time, for example due to fluid ageing, the control unit increases the flow rate of the fluid to maintain the optimum operating temperature of the battery. It is also possible, according to the invention, to adapt the thermal regulation system to single-phase dielectric heat-transfer liquids of different qualities. For example, for a single-phase dielectric heat-transfer liquid with a heat transfer capacity (or coefficient) lower, respectively higher, than a reference heat transfer capacity (or coefficient), the control unit increases, respectively reduces, the liquid flow rate to maintain the optimum battery operating temperature. For example, the control unit can selectively control the speed of rotation of the pumping element.

The invention also relates to a motor vehicle characterized in that it comprises a thermal regulation system as presented above, each battery module of which comprises electrical energy storage cells. Advantageously, according to the invention, all the technical features and effects of the thermal regulation system guarantee optimum operation of the electrical energy exchanges between the battery and the motor vehicle components, for example, when the motor vehicle is in motion or when recharging with electrical energy while the motor vehicle is parked.

### BRIEF DESCRIPTION OF THE FIGURES

Other features and advantages of the invention will become apparent from the description given below, by way of indication and in no way limiting, with reference to the accompanying drawings, wherein:

FIG. 1 is a schematic top view of an example vehicle in which a thermal regulation system according to the invention is mounted;

FIG. 2 is a schematic perspective view of an example of a thermal regulation system according to the invention;

FIG. 3 is an enlarged partial view of FIG. 2 centered on the battery;

FIG. 4 is a schematic view of the electrical and hydraulic connections of an example of a thermal regulation system according to the invention.

### DETAILED DESCRIPTION

In the following, the orientations are the orientations of the figures. In particular, the terms “upper”, “lower”, “left”, “right”, “above”, “below”, “forward” and “backward” are generally understood relative to the direction of representation of the figures. Furthermore, the terms “upstream” and “downstream” refer to the direction of flow of the dielectric heat-transfer liquid in the hydraulic network of the thermal regulation system.

In the present description, to clarify the explanation of the invention, elements for sensing temperature (T01, T02, etc.), presence (C02), flow (F03), quality (Q04), pressure (P01) or level (L04) are arbitrarily declared as a first sensing element, a second sensing element, and so on. This is a simple nomenclature for differentiating and naming the various elements of the thermal regulation system 1. This nomenclature does not mean that one sensing element has priority relative to another, and such designations can easily be changed without departing from the scope of the present description. Nor does this nomenclature imply an order, i.e. a third sensing element could be used without the need for a first sensing element and/or a second sensing element to implement the invention.

The invention applies to any type of thermal regulation system 1 by battery immersion, in particular those designed to equip a motor vehicle 4 such as a car, SUV (“Sport Utility Vehicles”), two-wheeler (especially motorcycles), aircraft, industrial vehicle chosen from vans, “heavy goods vehicles” (i.e. subways, buses, road transport vehicles (trucks, tractors, trailers), off-road vehicles such as agricultural or civil engineering machinery), or other transport or handling vehicles.

The motor vehicle 4 can be of the electric type, i.e. with at least one electric motor powered by at least one battery, of the hybrid type, i.e. with at least one internal combustion engine powered by at least one fuel (gasoline, liquefied petroleum gas, diesel, natural gas for vehicles, bio-fuel such as ethanol obtained from plant matter, etc.) and assisted by at least one electric motor powered by at least one battery and/or by the on-board network of the motor vehicle 4, of the fuel cell type, i.e. with at least one electric motor powered by at least one battery and/or by a fuel cell powered by dihydrogen and dioxygen, or of the rechargeable hybrid type, i.e. with at least one internal combustion engine powered by at least one fuel (petrol, liquefied petroleum gas, diesel, natural gas for vehicles, bio-fuel such as ethanol obtained from plant matter, etc.) and at least one electric motor powered by at least one battery.) and at least one electric motor powered by the on-board network of the motor vehicle 4 and/or at least one battery rechargeable by connection to an electrical network external to the motor vehicle 4. Of course, the invention is not limited to the above examples of motor vehicles 4, but can be applied to any type of motor vehicle 4 incorporating at least one battery without departing from the scope of the invention.

The term “thermal regulation system 1” refers to all types of systems 1 for controlling the flow, temperature and pressure of a dielectric heat-transfer liquid designed, by moving the said dielectric heat-transfer liquid around a part of the electrical energy storage cells 9 of a battery 3 (exchange by immersion in the dielectric heat-transfer liquid), to thermally exchange with said part of the electrical energy storage cells 9 in order to control its temperature, i.e. typically to heat and/or cool, according to a predetermined control, said part of the electrical energy storage cells 9 immersed in the dielectric heat-transfer liquid.

By “dielectric heat-transfer liquid” we mean a fluid intended to remain in liquid form in the hydraulic network 6 of the thermal regulation system 1 in order to exchange, by contact, the cold and/or heat of at least some of the electrical energy storage cells 9 of a battery 3. Typically, the dielectric heat-transfer liquid can be circulated around all or part of the electrical energy storage cells 9 by at least partially filling a battery 3 module 7. As explained above, the dielectric heat-transfer liquid is single-phase, i.e. it will not change phase (it will remain liquid) within the temperature range considered in normal operation such as, for example, between −40° C. and 60° C. According to the invention, the heat transfer liquid is dielectric, i.e. preferably has an electrical resistivity ρ at least equal to 1·10⁹ ohm meters (1 GΩ·m) at a temperature of 300 Kelvin (300 K) or, conversely, an electrical conductivity σ at most equal to 1·10⁻⁹ siemens per meter (1 nS·m⁻¹) at a temperature of 300 kelvins (300 K), so as not to disturb the electrical connections between, in particular, the cells 9 present in the same battery 3 module 7. This type of dielectric heat-transfer liquid can be similar to those used for electrical transformers. It will therefore not be described further in the present description as it is known per se. By way of example, the dielectric heat-transfer liquid can be a product of the Novec® 7500 type sold by 3M®, of the F18 or F20 type sold by Total® or of the DF7 or DFK type sold by MiVolt®.

By “electrical energy storage cell 9”, we mean all types of electrochemical accumulators capable of storing electrical energy and, in a reversible manner, releasing the stored electrical energy.

By “battery 3 module 7”, we mean a housing 8 designed to group together at least two electrical energy storage cells 9 electrically connected in series or in parallel. In the context of the invention, a dielectric heat-transfer liquid is circulated in at least one battery 3 module 7 to thermally regulate at least some of the electrical energy storage cells 9 that can be accommodated in the battery 3 module 7.

By “battery 3”, we mean all the modules 7 electrically connected in series or parallel and, incidentally, all the electrical energy storage cells 9 included in the modules 7.

By “powertrain 2”, we mean the assembly comprising the motor(s) designed to directly or indirectly drive the wheels of the motor vehicle 4, as well as the accessories for each motor such as, for example, the alternator, the cooling system, the gearbox or the lubrication system.

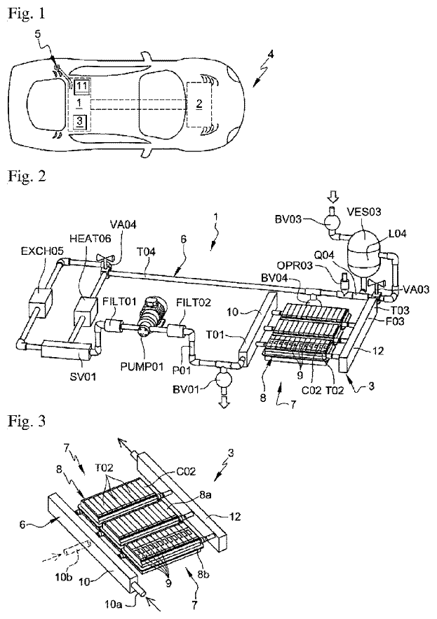

In the example shown in FIG. 1, a system 1 for thermal regulation of a battery 3 is fitted in a motor vehicle 4. In this example, an electrical connection element 5 is provided on the bodywork of the motor vehicle 4 to enable the recharging of the battery 3. As explained above, the thermal regulation system 1 and/or the battery 3 can be fluidically and/or electrically connected to the powertrain 2. Advantageously, according to the invention, all the technical features and effects of the thermal regulation system 1 guarantee optimum operation of the electrical energy exchanges between the battery 3 and the motor vehicle 4 components, for example, when the motor vehicle is in motion or when recharging with electrical energy while the motor vehicle is parked.

Advantageously, according to the invention, the thermal regulation system 1 is of the type with immersion of the electrical energy storage cells 9, i.e. each battery 3 module 7 comprises a housing 8 designed to enclose electrical energy storage cells 9 in dielectric heat-transfer liquid. Preferably, the electrical energy storage cells 9 of each battery 3 module 7 are fully immersed in dielectric heat-transfer liquid.

Firstly, immersion is more efficient for heat exchange, as the specific exchange surface is larger. Secondly, evacuation from each battery 3 module 7 by circulation of the dielectric heat-transfer liquid is rapid, enabling high control efficiency and responsiveness to satisfy both the charging (at fast-charging stations) and discharging (electrical consumption of the motor vehicle 4 at high load) of the battery's high electrical power. What's more, heat exchange is highly efficient, as it takes place directly by convection of the heat-transfer liquid on the envelope of each electrical energy storage cell 9. By the same token, immersion-type regulation is also safer against the spread of any battery 3 fire in the motor vehicle 4. It is therefore understood that the thermal regulation system 1 according to the invention makes it possible to maintain the electrical energy storage cells 9 at their optimum temperature in order to guarantee optimized (maintenance of the best energy yield) and robust (optimum charging and discharging for a longer service life) operation of the battery 3 whatever the external conditions in which the motor vehicle 4 operates, i.e. even if it is very cold or very hot.

The thermal regulation system 1 thus comprises a closed hydraulic network 6 wherein a flow of dielectric heat-transfer liquid in liquid phase is formed by means of at least one pumping element PUMP01. In the example shown in FIGS. 2 to 4, the hydraulic network 6 therefore includes all the modules 7 of the battery 3 (three in FIG. 3) so that the electrical energy storage cells 9 can be thermally regulated by the circulation of dielectric heat-transfer liquid in each housing 8. The hydraulic network 6 thus comprises a pipe structure on which a set of instruments is mounted, enabling the control unit 11 of the thermal regulation system 1 to manage the circulation of the dielectric heat-transfer liquid.

The hydraulic network 6 preferably comprises several battery 3 modules 7 connected in parallel, which offers several advantages. Firstly, it is simpler to regulate several battery 3 modules 7 in parallel than a single volume with the same number of electrical energy storage cells 9. It is also simpler to install several battery 3 modules 7 in parallel in a motor vehicle 4 than a single volume with the same number of electrical energy storage cells 9. Finally, it is simpler to be able to change a module 7 with faulty electrical energy storage cells 9 than to change the entire battery 3 for only a small portion of faulty electrical energy storage cells 9.

The pumping element PUMP01 pressurizes the dielectric heat-transfer liquid and circulates it through the hydraulic network 6. The pumping element PUMP01 must therefore ensure a given flow rate and overcome the pressure losses present in the 6 hydraulic network. As will be explained in greater detail above, it is directly controlled by the control unit 11 (sometimes referred to as the “battery thermal management system” or “BTMS”) as a function of measurements from the hydraulic network 6 instrumentation set.

In the example shown in FIGS. 2 to 4, filter elements FILT01 and FILT02 can be seen on either side of the pumping element PUMP01. Filter elements FILT01, FILT02 protect the components of the thermal regulation system 1 from external contamination. The filtration element FILT01 protects the pumping element PUMP01 from particles generated by filling the hydraulic network 6 with dielectric heat-transfer liquid, or generated by the electrical energy storage cells 9 (in the event of thermal runaway, for example). The filtration element FILT02 protects the electrical energy storage cells 9, for example by blocking particles that may be generated by the pumping element PUMP01 during its running-in phase.

Valves BV01, BV03 that are preferentially controllable are used to bleed the hydraulic network 6, in order to replace the dielectric heat-transfer liquid or a component of the thermal regulation system 1. To do this, the valve BV03 must first be opened to vent the hydraulic network 6. The valve BV01 must then be opened to allow the dielectric heat-transfer liquid to flow out of the hydraulic network 6. Preferably, as shown in the example shown in FIG. 2, the valve BV03 is located above, i.e. at a higher elevation above ground level, than most of the hydraulic network 6 and, conversely, the valve BV01 is located below, i.e. at a lower elevation above ground level, than most of the hydraulic network 6, thus facilitating the evacuation of the dielectric heat-transfer liquid with the aid of gravity. The hydraulic network 6 can then be refilled via the valve BV03 (having first closed the valve BV01). It can be seen that the valve BV03 communicates with the hydraulic network 6 via the expansion vessel VES03, making it easy to fill and regulate the volume of dielectric heat-transfer liquid in the hydraulic network 6.

In addition, the valve BV04 can be used to purge the system in the event of incorrect filling. In fact, as will be explained more fully below, when there is a liquid filling error, the liquid is contained between controllable proportional valves VA03 and VA04. The valve BV04 therefore enables this portion of the hydraulic network 6 to be emptied of any mistakenly inserted fluid.

The expansion vessel VES03 is located downstream of the valve VA03, so that the latter can function. The primary function of the expansion vessel VES03 is to compensate for thermal expansion of the dielectric heat-transfer liquid, or any other volume variations that may occur in the hydraulic network 6. As the dielectric heat-transfer liquid is considered incompressible, this protects the hydraulic network 6 from pressure increases and decreases in the dielectric heat-transfer liquid, which can damage components or impair their functionality. When the volume of the dielectric heat-transfer liquid changes, an inert gas in the expansion vessel VES03 expands or compresses to match the changes in the dielectric heat-transfer liquid. This gas will therefore rise or fall in pressure. This also means that in the event of a reduction in the volume of liquid in the circuit, the expansion vessel VES03 will also act as a reserve of dielectric heat-transfer liquid to supply the hydraulic network 6 and mitigate this reduction in volume.

The expansion vessel VES03 also helps cool the dielectric heat-transfer liquid in the hydraulic 6 network. As the hydraulic network 6 passes through the expansion vessel VES03, the thermal inertia of the cold dielectric heat-transfer liquid located in the expansion vessel VES03 absorbs some of the heat from the hot dielectric heat-transfer liquid coming from the battery 3 modules 7. This natural cooling reduces the energy consumption of the cooling system EXCH05 needed to regulate the temperature of the dielectric heat-transfer liquid.

In addition, the expansion vessel VES03 has an internal level-sensing element L04. It enables the control unit 11 to be warned when the level of dielectric heat-transfer liquid in expansion vessel VES03 is too low, which could mean a leak, for example. This may be an all-or-nothing sensor that sends a signal only when the level becomes critical, or a sensor sending back the liquid level in real time using, for example, a float moved by the level of dielectric heat-transfer liquid in the expansion vessel VES03.

The pressure relief valve OPR03 opens at high pressure. It protects the system from pressure increases too great to be compensated for by the expansion vessel VES03, in particular overpressures induced by gas release from an electrical energy storage cell 9 in the event of thermal runaway. This prevents the system from exploding under the increased pressure. The pressure relief valve OPR03 will therefore open when the pressure is too high, releasing the gas into the atmosphere to reduce the internal pressure of the hydraulic system 6, and closing again when the pressure returns to an acceptable level. The gas must be expelled far enough away from users to avoid endangering them. The pressure threshold at which the pressure relief valve OPR03 is triggered is preferably dependent on the operating pressure of the hydraulic network 6, i.e. it must not be triggered at a pressure too close to the operating pressure. The pressure threshold may, for example, be between 3.0 bar and 3.5 bar if the operating pressure of the hydraulic network 6 is 2 bar, i.e. equal to 3.0 bar, 3.1 bar, 3.2 bar, 3.3 bar, 3.4 bar or 3.5 bar. The pressure threshold for closing the pressure relief valve OPR03 can be, for example, between 2.5 bar and 3.0 bar, i.e. equal to 2.5 bar, 2.6 bar, 2.7 bar, 2.8 bar, 2.9 bar or 3.0 bar. Preferably, the difference between the values of the pressure thresholds between opening and closing of the pressure relief valve OPR03 can be, for example, between 0.5 bar and 1 bar, i.e. equal to 0.5 bar, 0.6 bar, 0.7 bar, 0.8 bar, 0.9 bar or 1.0 bar. Of course, these values may vary depending on the operating pressure of the hydraulic system 6.

The valve VA03, preferably of the controllable proportional type, is positioned between the battery 3 modules 7 and the expansion vessel VES03. It is also preferably located upstream of the valve BV03. The valve VA03 is controlled by control unit 11 according to the selected mode of thermal regulation system 1, as explained below. The valve VA03 allows partial bypass of the expansion vessel VES03. This bypass must be partial in order not to lose the functionality of the expansion vessel VES03, i.e. to compensate for thermal expansion of the dielectric heat-transfer liquid (this protects the thermal regulation system 1 from pressure increases and decreases in the dielectric heat-transfer liquid that could damage its components or impair their functionality). The partial bypass is designed to limit, in heating mode, the quantity of “hot” dielectric heat-transfer liquid passing through the expansion vessel VES03 in order to limit cooling of the dielectric heat-transfer liquid by heat exchange with the fluid present in the expansion vessel VES03. The proportion of bypassing, in heating mode, of valve VA03 can be, for example, between 10% and 80% to expansion vessel VES03, i.e. for example equal to 10%, 20%, 30%, 40%, 50%, 60%, 70%, or 80%, and the remainder to valve VA04. Preferably, the bypass ratio is managed by control unit 11 as a function of the temperature difference between the liquid inside the expansion vessel VES03 (using a temperature sensor mounted in the expansion vessel VES03) and the temperature measured by the third temperature sensing element T03 upstream of the expansion vessel VES03. More specifically, the greater the temperature difference, the more the proportion to the expansion vessel VES03 is reduced.

The normal position of the valve VA03 is fully open towards the expansion vessel VES03. In this way, in the event of a shutdown of the thermal regulation system 1, the dielectric heat-transfer liquid is automatically directed to the expansion vessel VES03, taking advantage of the thermal inertia provided by the vessel to cool the dielectric heat-transfer liquid. This makes the system safer in the event of thermal runaway of an electrical energy storage cell 9, by ensuring that no hot dielectric heat-transfer liquid is supplied to the electrical energy storage cells 9, which would increase the thermal runaway phenomenon.

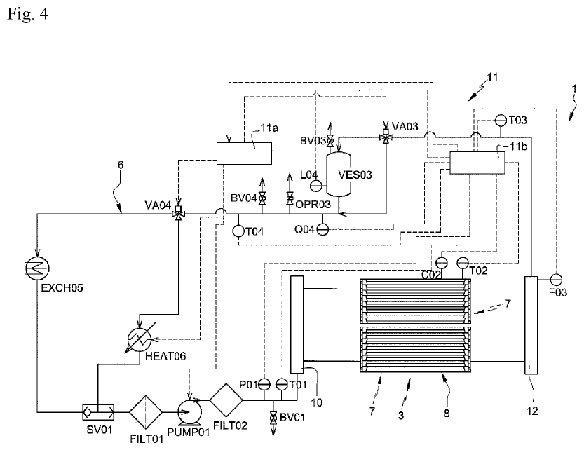

The valve VA04, preferably of the pilot-controlled proportional type, is preferably located between the expansion vessel VES03 and the cooling EXCH05 and heating HEAT06 devices. More specifically, the valve VA04 allows dielectric heat-transfer liquid to be selectively directed to either the cooling EXCH05 or heating HEAT06 device. In the example shown in FIGS. 2 and 4, the cooling EXCH05 and heating HEAT06 devices are connected in parallel, starting from the valve VA04. This is an on/off valve that can also be closed. It is therefore understood that the dielectric heat-transfer liquid can be directed entirely to either the cooling device EXCH05 or the heating device HEAT06, or it can be prevented from passing the valve VA04. The position of the valve VA04 depends on the strategy adopted by control unit 11 (heating mode, free circulation mode, cooling mode), as explained below. The normal position of the valve VA04 is fully open towards the cooling device EXCH05. So, if the thermal regulation system 1 is switched off, the dielectric heat-transfer liquid is automatically routed in its entirety to the cooling device EXCH05. This makes the thermal regulation system 1 safer in the event of thermal runaway of an electrical energy storage cell 9, by ensuring that no hot dielectric heat-transfer liquid is supplied to the electrical energy storage cells 9, which would worsen the thermal runaway phenomenon.

In the example shown in FIGS. 2 and 4, the parallel hydraulic network 6 sections comprising the cooling EXCH05 and heating HEAT06 devices, starting from the valve VA04, are joined by a shuttle valve SV01 upstream of the pumping element PUMP01. The latter is preferably a mechanical valve that opens under liquid pressure. The purpose of this valve, when one of the free circulation or heating modes is activated, is to prevent the pumping element PUMP01 from sucking dielectric heat-transfer liquid from the cooling circuit, which would result in the temperature of the dielectric heat-transfer liquid not changing to the desired value.

The cooling device EXCH05 is preferably made up of a cooling element and a heat exchanger with the dielectric heat-transfer liquid to selectively cool the dielectric heat-transfer liquid to a set temperature controlled by the control unit 11 before it reaches the shuttle valve SV01. The cooling element can advantageously be the cold circuit of a cooling system of the powertrain 2 of the motor vehicle 4 or a dedicated chiller.

The heating device HEAT06 is located in parallel with the cooling device EXCH05. It is preferably made up of a heating element and a heat exchanger with the dielectric heat-transfer liquid to selectively heat the dielectric heat-transfer liquid to a set temperature controlled by the control unit 11 before it reaches the shuttle valve SV01. The heating element can advantageously be the hot circuit of a heating system of the powertrain 2 of the motor vehicle 4 or a dedicated heater. The heating element is preferentially activated only in heating mode, and is switched off when the other modes are selected.

The battery 3 modules 7 are the heart of the thermal regulation system 1 and form part of the hydraulic network 6. They are designed to contain the electrical energy storage cells 9, which need to be thermally regulated. Preferably, a plurality of battery 3 modules 7 are hydraulically connected to the rest of the hydraulic network 6 via hydraulic connections to a common inlet manifold 10 and a common outlet manifold 12. In the example shown in FIGS. 2 to 4, the battery 3 modules 7 (three in FIGS. 2 and 3) are placed in parallel in the hydraulic network 6 to enable an equitable and homogeneous supply of dielectric heat-transfer liquid for each of the battery 3 modules 7, thus guaranteeing homogeneous thermal regulation of the electrical energy storage cells 9. This parallel arrangement also reduces pressure losses in the hydraulic network 6. In order to homogenize the pressure drops in each of the connections of the battery 3 modules 7 (and therefore to have similar flow rates in each module), the hydraulic connection section between the common inlet manifold 10 and its associated battery 3 module 7 is of different size depending on its distance from its connection to the hydraulic network 6 in order to obtain an equivalent dielectric heat-transfer liquid flow rate between the battery 3 modules 7. Typically, in the case of a lateral connection 10a of the common inlet ramp 10, the cross-section of each connection will increase as the connection moves further away from the lateral connection 10a. Another type of connection is also possible. By way of example, a connection 10b at the front (but also above or below) is also possible. In a similar way, the cross-section of the connections will be adapted to obtain an equivalent flow of dielectric heat-transfer liquid between the battery 3 modules 7.

The ramps 10, 12 are also used to position and hold the battery 3 modules 7 in position, so that forces are not transmitted via the hydraulic connections. The battery 3 modules 7 also enable the electrical connection of the electrical energy storage cells 9 to the rest of the motor vehicle 4 to guarantee its electrical energy supply. These electrical connections are made by waterproof connectors. The battery 3 modules 7 each comprise a housing 8 consisting of a lower recessed base 8b (accommodating the electrical energy storage cells 9) sealed by an upper cover 8a to provide protection for the electrical energy storage cells 9 against mechanical incidents (crashes, mechanical shocks, etc.) as well as protection in the event of fire (limits the progress of flames external to each battery 3 module 7 so that they do not reach the electrical energy storage cells 9).

In the example shown in FIGS. 2 and 4, the hydraulic network 6 instrumentation set comprises elements for detecting temperature T01, T02, T03, T04, pollution C02, flow F03, quality Q04 and pressure P01 (in addition to the expansion vessel level sensing element L04 VES03), enabling the control unit 11 of the thermal regulation system 1 to manage the circulation of the dielectric heat-transfer liquid. The control unit 11 thus comprises a module 11a for processing, i.e. a programmable intelligence, based on the measurements received by the module 11b for receiving the set of instruments of the hydraulic network 6, in order to manage the thermal regulation system 1 according to the measurements of the set of instruments of the hydraulic network 6. Of course, the instrumentation package could include more or fewer sensing elements depending on the applications and/or the desired complexity of the thermal regulation system 1

The pressure sensing element P01 measures the pressure of the dielectric heat-transfer liquid in the hydraulic network 6 at the outlet of the pumping element PUMP01. In order to avoid any pressure losses that could distort the pressure measurement, it is preferably located as close as possible downstream of the pumping element PUMP01. The value measured by the pressure sensing element P01 is transmitted to the control unit 11, which analyzes it and makes it possible to manage a possible correction of the operation of the pumping element PUMP01 (rotation speed, flow rate, etc.) and/or to diagnose problems in the hydraulic network 6 (leaks or obstructions (at least partial blockage) of the hydraulic network 6).

Each battery 3 module 7 preferably comprises at least one pollution sensing element C02 in close proximity to the electrical energy storage cells 9, in order to detect the deterioration of at least one of its electrical energy storage cells 9. More precisely, each pollution sensing element C02 is designed to detect whether at least one gas is escaping from the electrical energy storage cells 9 when at least one of them is subjected to thermal runaway. This is because an exhaust valve is usually provided, often formed by a frangible part designed to break at a predetermined internal pressure, to let excess pressure escape outside the electrical energy storage cell 9. Once the exhaust valve is opened, the electrical energy storage cell 9 is no longer functional. Each C02 pollution sensing element can therefore be a composition, pressure, transparency or electrical conductivity sensor to determine whether a gas has escaped from at least one of the electrical energy storage cells 9 of the battery module 7 in order to diagnose thermal runaway. Thus, when the presence of such pollution gases is detected in a battery 3 module 7, the control unit 11 can impose the shutdown of the thermal regulation system 1 and send an alert identifying each faulty module 7 before an electrical energy storage cell 9 catches fire. Once the faulty module 7 has been identified, it can be replaced without affecting the other modules 7.

The flow sensing element F03 is preferably mounted at the end of the common output manifold 12 as close as possible upstream of valve VA03. By placing it after the battery 3 modules 7, it is possible to know the overall flow rate through all the battery 3 modules 7, even in the event of a leak between the flow sensing element F03 and the pumping element PUMP01. The flow sensing element F03 may consist of a flow meter. The F03 flow sensing element enables the control unit 11 to manage a possible correction of the operation of the pumping element PUMP01 (rotation speed, flow rate, etc.) in order to supply the electrical energy storage cells 9 with the flow rate required to cool them and/or to estimate the possible thermal regulation power.

In the example shown in FIGS. 2 to 4, a number of temperature sensing elements T01, T02, T03, T04 are provided to monitor the temperature of the dielectric heat-transfer liquid at a number of predetermined locations in the hydraulic network 6. Each temperature sensing element T01, T02, T03, T04 may comprise at least one temperature sensor, for example of the thermocouple type or another type.

A first temperature sensing element T01 can be used to measure the temperature of the liquid upstream of the battery 3 modules 7 and downstream of the pumping element PUMP01. In order to obtain as accurate a value as possible of the temperature of the dielectric heat-transfer liquid entering the battery 3 modules 7, the first temperature sensing element T01 must be located as close as possible upstream of the inlet to the battery 3 modules 7. It is also preferably located downstream of the pumping element PUMP01, to take account of possible heating of the dielectric heat-transfer liquid by the pumping element PUMP01. The first temperature sensing element T01 enables the control unit 11 to manage the cooling EXCH05 and heating HEAT06 devices and/or to diagnose a malfunction of the cooling EXCH05 and heating HEAT06 devices (with another temperature sensing element T03, T04 as explained below) and/or to diagnose the presence of flames external to the thermal regulation system 1.

Each battery 3 module 7 preferably features at least one second temperature sensing element T02 (three in FIG. 3) closest to the electrical energy storage cells 9. Each second temperature sensing element T02 enables the control unit 11 to manage the operating mode of the thermal regulation system 1 (heating mode, free circulation mode or cooling mode) and/or to diagnose the presence of flames outside the thermal regulation system 1.

A third temperature sensing element T03 can be located as close as possible to the output of the battery 3 modules 7, so that the measurement is as representative as possible of the temperature of the dielectric heat-transfer liquid at the output of the battery 3 modules 7. The third temperature sensing element T03 enables the control unit 11 to diagnose poor heat exchange between the electrical energy storage cells 9 and the dielectric heat-transfer liquid (unexpected temperature variation) and/or to diagnose a malfunction of the EXCH05 cooling and HEAT06 heating devices and/or to diagnose the presence of flames outside the thermal regulation system 1.

A fourth temperature sensing element T04 can be located between expansion vessel VES03 and valve VA04. The fourth temperature sensing element T04 enables the control unit 11 to diagnose a malfunction of the EXCH05 cooling and HEAT06 heating devices and/or to diagnose the presence of flames outside the thermal regulation system 1.

The hydraulic network 6 is therefore constantly monitored to avoid malfunctioning of the control system 1 components, such as a disturbance in the circulation of the dielectric heat-transfer liquid, a heating and/or cooling deficit or insufficient entrainment of the dielectric heat-transfer liquid flow, which could render the thermal regulation of the electrical energy storage cells 9 present in the battery 3 module 7 less effective. It is understood that the regulation system 1 according to the invention therefore enables safer operation (maintenance of regulation quality) and greater reliability (maintenance of safe operating conditions for the regulation system 1/battery assembly 3, enabling a longer service life for the assembly). It can be concluded that the phenomena of battery thermal 3 runaway will be avoided thanks to the thermal regulation system 1, which will limit the situations in which irreversible damage to electrical energy storage cells 9 could be caused.

The thermal regulation system 1 may comprise at least one second temperature sensing element T02 inside the battery 3 module 7 electrically connected to the control unit 11 in order to selectively control the operating mode of the thermal regulation system 1 as a function of the value measured by the second temperature sensing element T02 and a predetermined target temperature of the battery 3 module 7. Each temperature measured in each battery 3 module 7 is preferably monitored continuously, and as soon as one of the temperatures drifts beyond predetermined thresholds above or below the predetermined target temperature, the control unit 11 activates the cooling mode, or heating mode, respectively. If each of the temperature measurements remains within the range of predetermined thresholds above or below the predetermined target temperature, the control unit 11 activates the free circulation mode, which simply draws the dielectric heat-transfer liquid into the hydraulic network 6 without heating or cooling it. Of course, the predetermined target temperature and the predetermined thresholds can be different for each battery 3 module 7 depending on its configuration and/or location in the motor vehicle 4. As a non-limiting example, the predetermined target temperature can be between 15° C. and 30° C., i.e. equal to 15° C., 20° C., 25° C. or 30° C., and the predetermined thresholds between 10% and 30%, i.e. equal to 10%, 15%, 20%, 25% or 30%, of the predetermined target temperature e.

In addition, the control unit 11 is preferably configured to switch the valve VA04 to the heating device HEAT06 by activating the latter when the value measured by the second temperature sensing element T02 is lower than the predetermined target temperature of the battery 3 module 7 in order, in heating mode, to heat up at least some of the electrical energy storage cells 9 included in the battery 3 module 7 to the predetermined target temperature of the battery 3 module 7. Again, depending on predetermined thresholds above or below the predetermined target temperature (which are not necessarily equal), the control unit 11 activates or deactivates the heating mode.

Conversely, the control unit 11 is preferably configured to switch the valve VA04 to the cooling device EXCH05 by activating the latter when the value measured by the second temperature sensing element T02 is greater than the predetermined target temperature of the battery 3 module 7 in order, in cooling mode, to cool at least some of the electrical energy storage cells 9 included in the battery 3 module 7 to the predetermined target temperature of the battery 3 module 7. Again, depending on predetermined thresholds above or below the predetermined target temperature (which are not necessarily equal, nor necessarily identical to those in heating mode), the control unit 11 activates or deactivates the cooling mode.

It is also understood that the thermal regulation system 1 can continuously adapt to the external conditions in which the motor vehicle 4 is operating, i.e. both cold conditions (cell heating 9) and hot conditions (cell cooling 9). It is also immediate that the control unit 11 can thus, in a first step, heat each battery 3 module 7 to arrive at the optimum battery 3 operating temperature such as, for example, thirty degrees Celsius and, in a second step, thermally regulate (heat or cool) each battery 3 module 7 to maintain the optimum battery 3 operating temperature.

In addition, the control unit 11 selectively controls, in heating mode, the activation intensity of the heating device HEAT06 according to the value measured by the first temperature sensing element T01. It is therefore understood that the heating intensity applied to the dielectric heat-transfer liquid is not controlled by the same temperature sensing element T01 as that T02 used to select the operating mode of thermal regulation system 1. This makes it possible to control the intensity of the heating device HEAT06 on the basis of a temperature measurement upstream of the battery 3 module 7.

Conversely, in cooling mode, the control unit 11 selectively controls the activation intensity of the cooling device EXCH05 as a function of the value measured by first temperature sensing element T01 (which may be the same as that used for heating mode). It is therefore also understood here that the cooling intensity applied to the dielectric heat-transfer liquid is not controlled by the same temperature sensing element T01 as that T02 used to select the operating mode of thermal regulation system. This makes it possible to control the intensity of the cooling device EXCH05 on the basis of a temperature measurement upstream of the battery 3 module 7.

On the one hand, this enables the control unit 11 to precisely regulate the temperature upstream of the battery 3 module 7, i.e. before interaction with the electrical energy storage cells 9, and, on the other hand, as the battery 3 is preferably designed to comprise a plurality of modules 7, it provides a homogeneous dielectric heat-transfer liquid inlet temperature in each module 7.

Finally, in heating mode, the control unit 11 can diagnose a failure of the heating device HEAT06 if the value measured by the fourth temperature sensing element T04 is not lower than the value measured by the first temperature sensing element T01 (if the relationship T04≥T01 is satisfied). By means of simple instrumentation, the control unit 11 of the thermal regulation system 1 is immediately able to detect whether the dielectric heat-transfer liquid has actually been heated by the heating device HEAT06. It is also immediate that, if the value measured by the third temperature sensing element T03 is not lower than the value measured by the first temperature sensing element T01 (if the relationship T03≥T01 is satisfied), i.e. a drop in temperature between upstream and downstream of the battery 3 module 7 is not observed, that the electrical energy storage cells 9 have not been warmed up.

Conversely, in cooling mode, the control unit 11 can diagnose a failure of the cooling device EXCH05 if the value measured by the temperature sensing element T04 is not greater than the value measured by the first temperature sensing element T01 (if the relationship T04≥T01 is satisfied). By means of simple instrumentation, the control unit 11 of the thermal regulation system 1 is immediately able to detect whether the dielectric heat-transfer liquid has actually been cooled by the cooling device EXCH05. It is also immediate that, if the value measured by the third temperature sensing element T03 is not greater than the value measured by the first temperature sensing element T01 (if the relationship T03≤T01 is satisfied), i.e. a rise in temperature between upstream and downstream of the battery 3 module 7 is not observed, that the electrical energy storage cells 9 have not been cooled down.

The control unit 11 is preferably configured to diagnose an obstruction of a battery 3 module 7 when the variations in values of the second temperature sensing elements T02 inside each battery 3 module 7 are different. As the battery 3 modules 7 are in parallel and supplied by the same dielectric heat-transfer liquid at the same temperature, a variation in the temperature of one battery 3 module 7 beyond a predetermined threshold above the average temperature of the other battery 3 modules 7, can lead to the conclusion that a circulation fault is present in the battery 3 module 7 where the temperature variation changes more markedly than in the others. This means that diagnostics by control unit 11 can be used to quickly check for any faulty electrical energy storage cells 9 or obstructions, knowing which battery 3 module 7 is to be checked.

The control unit 11 is preferably configured to vary the flow rate of the pumping element PUMP01 as a function of the electrical charging or discharging power of the battery 3, in order to adapt the circulation flow of the dielectric heat-transfer liquid in the hydraulic network 6 to the operation of the battery 3. It is therefore understood that the higher the charging or discharging power of the battery 3, the higher the flow rate of the PUMP1 pumping element, so the volume per unit time of dielectric heat-transfer liquid passing through each battery 3 module 7 is higher, to increase the thermal regulation capacity of the system 1. According to one example, the flow rate variation of the pumping element PUMP01 could be proportional to the charging or discharging power of the battery 3.

The control unit 11 can selectively drive the pumping element PUMP01 according to the value measured by the flow sensing element F03. In fact, it may be useful to measure the effective flow rate after the pressure losses experienced in each battery 3 module 7 in order, if necessary, to correct the control of the pumping element PUMP01 to obtain the thermal regulation power actually desired, depending on the volume per unit time of dielectric heat-transfer liquid passing through each battery 3 module 7.

By comparing the value measured by the pressure sensing element P01 with the pressure estimated from the operating conditions of the pumping element PUMP01, the control unit 11 can diagnose a leak or, conversely, an obstruction in the hydraulic network 6. Here again, if the hydraulic system 6 has no faults, this diagnosis would not be necessary. However, in the case of a thermal regulation system 1 installed in a motor vehicle 4, it may be useful to measure the effective pressure between the pumping element PUMP01 and each battery 3 module 7, in order to determine, if the pressure is higher than a predetermined threshold than the theoretical one for the current operation of the pumping element PUMP01, that the circulation of the dielectric heat-transfer liquid is impeded in the hydraulic network 6 or, on the contrary, to determine, if the pressure is lower than a predetermined threshold than the theoretical one of the current operation of the pumping element PUMP01, that some of the dielectric heat-transfer liquid is escaping from the hydraulic network 6. This means that diagnostics by the control unit 11 can be used to quickly check the hydraulic network 6 before any electrical energy storage cells 9 fail due to poor thermal regulation.

Advantageously according to the invention, the control unit 11 of the regulation system is also configured to monitor the quality of the dielectric heat-transfer liquid in order to guarantee that the battery 3 is in good working order. Thus, according to the invention, the dielectric heat-transfer liquid surrounding the electrical energy storage cells is continuously monitored to prevent pollution from being introduced into the battery 3 module 7 through the circulation of the dielectric heat-transfer liquid, which could render thermal regulation less effective or lead to short circuits between the electrical energy storage cells 9 present in the battery 3 module 7. It is understood that the thermal regulation system 1 according to the invention therefore enables safer operation (maintenance of regulation quality) and greater reliability (maintenance of safe operating conditions for the regulation system 1/battery assembly, enabling a longer service life for the assembly). It can be concluded that the phenomena of battery 3 thermal runaway will be avoided thanks to the thermal regulation system 1 according to the invention, which will limit the situations in which irreversible damage to electrical energy storage cells could be caused.

The thermal regulation system 1 according to the invention comprises at least one element Q04 for detecting at least one physical value of the dielectric heat-transfer liquid, mounted on the hydraulic network 6 and electrically connected to the control unit 11. In this way, it can capture both pollution induced by incorrect filling and pollution in the thermal regulation system 1 itself (e.g. from electrical energy storage cells 9). If the quality sensing element Q04 were located only on the filling circuit, internal pollution would not be detectable. The control unit 11 can thus selectively control the operation of the thermal regulation system 1 as a function of the physical value of the dielectric heat-transfer liquid measured by the sensing element Q04. This configuration makes it possible to continuously determine the presence or absence of pollution in the dielectric heat-transfer liquid simply by monitoring one of its physical values, without having to intervene in the hydraulic network 6, i.e. typically without having to take dielectric heat-transfer liquid samples from the hydraulic network 6. It is also possible under the invention to immediately detect whether the liquid used to fill the hydraulic network 6 is not the one expected. Preferably, when pollution is determined, the treatment unit 11 blocks the circulation of the dielectric heat-transfer liquid in the hydraulic network 6 by stopping at least the pumping element PUMP014 to prevent any pollution from entering each battery 3 module 7 as soon as possible.

Preferably, the sensing element Q04 is an electrical conductivity sensor (or conversely an electrical resistivity sensor) so that the control unit 11 selectively determines whether a risk of thermal deregulation (less efficient heat exchange) and/or a risk of short-circuit (possible electrical connection via the dielectric heat-transfer liquid) is incurred in the battery 3 module 7 by the presence of the single-phase dielectric heat-transfer liquid. Indeed, pollution is generally associated with a variation in electrical conductivity (electrical resistivity being the inverse of electrical conductivity) and this physical value has important consequences for the electrical connections in the battery 3 module 7 and, more generally, for the working order of the battery 3. By way of example, the sensing element Q04 can be an electrode sensor.

The quality threshold of the control unit 11, i.e. the threshold above which the control unit 11 will consider that pollution is no longer negligible, may for example be an electrical conductivity σ at most equal to 1 nS·m⁻¹ or an electrical resistivity ρ at least equal to 1 GΩ·m at a temperature of 300 K. Indeed, depending on the temperature of the dielectric heat-transfer liquid, the electrical conductivity and, incidentally, the electrical resistivity, vary.

The sensing element Q04 is preferentially mounted on the hydraulic network 6 outside the battery 3 module 7, enabling the control unit 11 to stop the circulation of the dielectric heat-transfer liquid before it reaches each battery 3 module 7 when a predetermined threshold, such as the above quality threshold, is exceeded by the sensing element Q04 measurement. Typically, if there is an inlet for filling the hydraulic network 6 with dielectric heat-transfer liquid such as valve BV03 is present, the sensing element Q04 is preferentially installed downstream and as close as possible to this filling inlet to maximize the speed of detection of a fluid filling error, i.e. in particular if the liquid introduced into the hydraulic network 6 is not the expected dielectric heat-transfer liquid, and sufficiently upstream of each battery 3 module 7 so that the inertia of the thermal regulation system 1 does not cause the liquid to reach each battery 3 module 7 after the shutdown activated by the control unit 11.

Finally, in the event of poor liquid quality being detected by quality sensing element Q04, the control unit 11 shuts down the main components of the thermal regulation system 1 (pumping element PUMP01, the cooling device EXCH05, heating device HEAT06, etc.). In addition, the control unit 11 can completely close the valve VA03 or prevent poor-quality dielectric heat-transfer liquid from reaching the battery 3 module 7 (opening only between upstream and downstream of expansion vessel VES03). In addition, the control unit 11 can close the valve VA04 completely, i.e. redirect the liquid in the cooling circuit. In the absence of pressure, this will be blocked by the shuttle valve SV01. The aim is also to prevent poor-quality liquid from reaching the battery 3 modules 7.

Advantageously according to the invention, the control unit 11 can vary the flow rate of the single-phase dielectric heat-transfer liquid as a function of the physical value of the single-phase dielectric heat-transfer liquid measured by the sensing element Q04. This makes it possible to dynamically adapt the thermal regulation system 1 to the quality of the single-phase dielectric heat-transfer liquid. For example, for a given single-phase dielectric heat-transfer liquid whose heat transfer capacity (or coefficient) degrades over time, for example due to fluid ageing, the control unit 11 increases the flow rate of the fluid to maintain the optimum operating temperature of the battery 3.

It is also possible, according to the invention, to adapt the thermal regulation system 1 to single-phase dielectric heat-transfer liquids of different qualities. For example, for a single-phase dielectric heat-transfer liquid with a heat transfer capacity (or coefficient) lower, respectively higher, than a reference heat transfer capacity (or coefficient), the control unit 11 increases, respectively reduces, the liquid flow rate to maintain the optimum battery operating temperature. For example, the control unit can selectively control the speed of rotation of the pumping element.

The invention is not limited to the embodiments and variants presented, and other embodiments and variants will become clearly apparent to the person skilled in the art. Thus, the various embodiments and variants can be combined with one another without departing from the scope of the invention. In non-limiting fashion, it is possible that another type of sensing element Q04 may be used without going beyond the scope of the invention.

### LIST OF REFERENCES

1—thermal regulation system
2—powertrain
3—battery
4—motor vehicle
5—electrical connection element
6—hydraulic network
7—battery module
8—housing of the battery module
8a—upper cover of the
8b—lower recessed base of the housing
9—electrical energy storage cells
10—common intake ramp
10a—side intake
10b—central intake
11—control unit
11a—processing module
11b—reception module
12—common outlet ramp
T01—temperature sensing element
T02—module temperature sensing element
T03—temperature sensing element
T04—temperature sensing element
C02—module pollution sensing element
F03—dielectric heat-transfer liquid flow sensing element
Q04—sensing element for a physical value of the dielectric heat-transfer liquid
P01—pressure sensing element
L04—level sensing element in expansion vessel
BV01—controllable valve
BV03—controllable valve
BV04—controllable valve
VA03—controllable proportional valve
VA04—controllable proportional valve
SV01—shuttle valve
VES04—expansion vessel
OPR03—pressure relief valve
FILT01—filter element
FILT02—filter element
PUMP01—pumping element
EXCH05—cooling device
HEAT06—heating device

1. A thermal regulation system for a motor vehicle battery comprising a closed hydraulic network in which a flow of single-phase dielectric heat-transfer liquid is formed by means of at least one pumping element, the hydraulic network comprising at least one battery module suitable for accommodating electrical energy storage cells to be thermally regulated by immersion in the single-phase dielectric heat-transfer liquid by means of at least partial filling of the battery module with the single-phase dielectric heat-transfer liquid, wherein the system comprises:
at least one sensing element for sensing at least one physical value of the single-phase dielectric heat-transfer liquid, mounted on the hydraulic network and electrically connected to a control unit in order to selectively activate the operation of the thermal regulation system as a function of the physical value of the single-phase dielectric heat-transfer liquid measured by the sensing element, in order to ensure the working order of the battery.

2. The thermal regulation system according to claim 1, wherein the sensing element is an electrical conductivity sensor so that the control unit selectively determines whether a risk of thermal deregulation and/or a risk of short-circuiting is incurred in the battery module by contact with the single-phase dielectric heat-transfer liquid.

3. The thermal regulation system according to claim 1, wherein the quality threshold of the control unit is an electrical conductivity at most equal to 1 nS·m⁻¹ at a temperature of 300 K.

4. The thermal regulation system according to claim 1, wherein the sensing element is an electrical conductivity sensor so that the control unit selectively determines whether a risk of thermal deregulation and/or a risk of short-circuiting is incurred in the battery module by contact with the single-phase dielectric heat-transfer liquid.

5. The thermal regulation system according to claim 4, wherein the quality threshold of the control unit is an electrical resistivity at most equal to 1 GΩ·m at a temperature of 300 K.

6. The thermal regulation system according to claim 1, wherein the sensing element is mounted on the hydraulic network outside the battery module enabling the control unit to stop the circulation of the single-phase dielectric heat-transfer liquid before the liquid reaches the battery module when a predetermined threshold is exceeded by the measurement of the sensing element.

7. The thermal regulation system according to claim 1, further comprising a device for heating the single-phase dielectric heat-transfer liquid present in the hydraulic network in order to heat at least some of the electrical energy storage cells in the battery module.

8. The thermal regulation system according to claim 1, further comprising a device for cooling the single-phase dielectric heat-transfer liquid present in the hydraulic network in order to cool at least some of the electrical energy storage cells in the battery module.

9. The thermal regulation system according to claim 1, wherein the control unit varies the flow rate of the single-phase dielectric heat-transfer liquid as a function of the physical value of the single-phase dielectric heat-transfer liquid measured by the sensing element.

10. A motor vehicle comprising a thermal regulation system according to claim 1, wherein each battery module of which comprises electrical energy storage cells.
